(19) United States
(12) Patent Application Publication
(10) Pub. No.: US 2018/0057761 A1
(43) Pub. Date: Mar. 1, 2018

(54) CONTINUOUS SLAG HANDLING SYSTEM

(71) Applicant: General Electric Company, Schenectady, NY (US)

(72) Inventors: Manuja Nunna, Bangalore (IN); Uma Chinnadurai, Bangalore (IN); Chandrakala Radhakrishnan, Bangalore (IN)

(21) Appl. No.: 15/253,029

(22) Filed: Aug. 31, 2016

(51) Int. Cl. C10J 3/52; C10J 3/48; C10J 3/46; C10J 3/84; C10K 1/08; C01B 3/02; C01B 3/52

(52) U.S. Cl. CPC C10J 3/526; C10J 3/485; C10J 3/466; C10J 3/84; C01B 2203/148; C01B 3/02; C01B 3/52; C10J 2300/1671; C01B 2203/0415; C10K 1/08

(57) ABSTRACT

A system includes a slurry inlet of the gasifier that receives a feedstock slurry and a gasification section of the gasifier that gasifies the feedstock slurry to produce syngas. The system includes a quench chamber to cool the syngas produced in the gasification section using a liquid feed to produce a quench blow down and quenched syngas. The quench blow down has solids produced as a by-product from gasification. The system includes a quench blowdown outlet which discharges the quench blow down and a slag sump liquid such that the solids concentration of the quench blowdown is reduced. The system includes a syngas outlet which discharges the syngas and a syngas scrubber fluidly coupled to the syngas outlet and to the quench chamber. The syngas scrubber includes a syngas inlet, a scrubbed syngas outlet, and a scrubber blow down outlet fluidly coupled to a fluid inlet of the gasifier.

### BACKGROUND

The subject matter disclosed herein relates to gasification systems, and more particularly to a continuous slag handling system for slag produced during gasification.

Gasification involves reacting a carbonaceous fuel and oxygen at a very high temperature within a gasifier to produce syngas, a fuel containing carbon monoxide and hydrogen. The gasification process may also produce solid by-product materials. For instance, gasification of certain carbonaceous materials may also produce heavy ash or molten slag. Solid by-products such as these may be removed from the gasifier along a path that is separate from the syngas, along with other, more dense materials or a gasifier blowdown. This gasifier blowdown may have a relatively high pressure and temperature. It is now recognized that systems for handling the gasifier blowdown may be subject to further improvement.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the claimed subject matter. Indeed, the claimed subject matter may encompass a variety of forms that may be similar to or different from the embodiments set forth below.

In a first embodiment, a system includes a slurry inlet of the gasifier that receives a feedstock slurry and a gasification section of the gasifier that gasifies the feedstock slurry to produce syngas. The system includes a quench chamber of the gasifier configured to cool the syngas produced in the gasification section using a liquid feed to produce a quench blow down and quenched syngas. The quench blow down has solids produced as a by-product from gasification of the feedstock slurry and the liquid feed. The system includes a quench blowdown outlet configured to discharge the quench blow down in combination with a slag sump liquid such that the solids concentration of the quench blowdown is reduced by the slag sump liquid. The system includes a syngas outlet configured to discharge the syngas and a syngas scrubber fluidly coupled to the syngas outlet and to the quench chamber. The syngas scrubber includes a syngas inlet fluidly coupled to the syngas outlet of the gasifier, a scrubbed syngas outlet which discharges scrubbed syngas generated from scrubbing the syngas, and a scrubber blow down outlet fluidly coupled to a fluid inlet of the gasifier and configured to provide a scrubber blow down to the quench chamber as all or a part of the liquid feed.

In a second embodiment, a system includes a gasifier including a slurry inlet which receives a slurry, a quench blow down outlet which discharges a quench blow down, and a syngas outlet which discharges syngas produced from gasification of the slurry. The system includes a syngas scrubber including a syngas inlet fluidly coupled to the syngas outlet of the gasifier, a scrubbed syngas outlet which discharges scrubbed syngas generated from scrubbing the quenched syngas, and a scrubber blow down outlet fluidly coupled to a fluid inlet of the gasifier which provides a scrubber blow down. The system includes an expansion system fluidly coupled to the gasifier outlet, where the expansion system receives the quench blow down and a slag sump liquid, wherein the solids concentration of the quench blow down is reduced by the slag sump liquid.

In a third embodiment, a method includes directing a fluid exiting a syngas scrubber disposed downstream and coupled to a gasifier to a fluid inlet of the gasifier, wherein the fluid inlet is disposed between a gasifier inlet and a quench blow down outlet disposed along a bottom portion of the gasifier. The method includes discharging a quench blow down including a quenched syngas generated in a gasification section of the gasifier through the quench blow down outlet and directing the quench blow down and a slag sump liquid to a hydraulic power recovery turbine system.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a schematic overview of an embodiment of a gasification system including a continuous slag removal system;

FIG. 2 is a detailed schematic diagram of an embodiment of the gasification system and the continuous slag removal system including a syngas scrubber and an expansion system, which includes a hydraulic pump recovery turbine; and

FIG. 3 is a detailed schematic diagram of an embodiment of the power plant in which a water processing system includes one or more centrifuges.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments described herein pertain to a continuous slag removal system associated with the gasification system. The continuous slag removal system reduces equipment and costs associated with utilizing conventional slag removal systems. Typical slag removal systems are often operated in a non-continuous (e.g., batch) manner. For example, in non-continuous slag removal systems, the cycle of slag removal may last between approximately 15 to 45 minutes. When the slag removal cycle is over, the slag removal equipment (e.g., a lock hopper) is depressurized to remove slag from the slag removal equipment. When the slag removal equipment is being depressurized, the non-continuous slag removal system does not remove slag. The cyclical nature of such slag removal systems may increase maintenance costs associated with equipment designed to handle cyclical use and pressure variations (e.g., valves). Such slag removal systems may also require a greater vertical drop between the gasifier and the slag removal equipment so the slag can be removed from the bottom of the gasifier due to the structure and size of the equipment utilized (e.g., a lock hopper). The supporting structural equipment also adds to equipment costs of such slag removal systems. Such slag removal systems also require the slag to drop through a slag sump, which may increase water usage significantly.

The continuous slag removal system disclosed herein addresses these and other concerns. The continuous slag removal system described herein apply to gasification systems, including gasifiers used to produce a synthesis gas (syngas). The continuous slag removal system may provide certain benefits when compared to non-continuous (e.g., conventional) slag removal systems. For example, the system described herein may dilute the amount of solids in the gasifier blow down, reduce the amount of equipment and costs associated with slag removal, and increase slag removal efficiency, among others.

The continuous slag removal system disclosed herein may be used in combination with a gasifier having a slurry inlet, a gasifier outlet, and a syngas outlet, where the gasifier is configured to gasify the slurry to generate the syngas. The gasifier is fluidly coupled to a syngas scrubber. The syngas scrubber includes a syngas inlet and a syngas outlet, where the syngas flows through a syngas conduit to the syngas inlet to enable the syngas scrubber to receive the syngas generated from the gasifier. The syngas scrubber is configured to scrub the syngas and to discharge a scrubbed syngas and a scrubber blow down. The scrubber blow down may be directed back into to the gasifier through a fluid inlet of the gasifier via a scrubber blow down path. The fluid inlet may be disposed between the slurry inlet and the gasifier outlet. The scrubber blow down may dilute the solids (e.g., slag) output by the gasifier such that a solids concentration in the gasifier blow down that is expelled from the gasifier outlet is less than approximately 5%. The reduction in solids may improve the overall efficiency of the continuous slag removal system by improving processing.

The continuous slag removal system disclosed herein may include an expansion system coupled to the gasifier outlet. The expansion system may help reduce the amount of equipment and costs associated with slag removal. Utilizing the expansion systems disclosed herein enables the gasifier to be positioned closer to ground level, thereby reducing the amount of equipment when compared to the amount of equipment used to accommodate slag removal in non-continuous (e.g., conventional) slag removal systems. For example, supporting structural equipment for a gasifier may increase the costs associated with gasification systems. For example, in some conventional slag removal systems, the gasifier may be disposed approximately 12-15 meters (m) (approximately 40-50 feet (ft.)) above the slag removal equipment (e.g., a slag sump, at least one flash drum, control valves, a lock hopper, and so forth). In contrast, the continuous slag removal system disclosed herein may utilize a hydraulic pressure recovery turbine (HPRT) in place of the slag removal equipment (e.g., a slag sump, at least one flash drum, control valves, a lock hopper). Eliminating the slag removal equipment (e.g., a slag sump, at least one flash drum, control valves, a lock hopper) used in non-continuous (e.g., conventional) slag removal systems reduces the costs associated with operating and maintaining the conventional slag removal system. Moreover, eliminating large pieces of equipment (e.g., a lock hopper) enables the gasifier to be positioned at ground level because the gasifier does not need to be positioned above the lock hopper to promote slag removal. Utilizing the HPRT in place of the slag removal equipment (e.g., a slag sump, at least one flash drum, control valves, a lock hopper) also reduces the amount of supporting structural equipment that is used to support the height of the slag removal equipment (e.g., a lock hopper, a flash drum). The HPRT is sufficient to reduce the pressure of the gasifier blow down when the lock hopper is eliminated so that the gasifier blow down can be expanded and subject to further treatment (e.g., in a water treatment system).

In accordance with some embodiments, a water treatment system (e.g., a blackwater treatment system to produce greywater) may process the gasifier blow down into a usable water source (e.g., greywater) within the plant. The water treatment system may include a flash drum coupled to an outlet of the HPRT to receive the expanded gasifier blow down. By utilizing the HPRT to expand the gasifier blow down, the number of flash drum can be reduced compared to the number of flash drums utilized in conventional slag removal systems (e.g., because of the reduced pressure). The pressure of the gasifier blow down (e.g., the slag) is less than when the slag travels through approximately 12-15 meters (m) (approximately 40-50 feet (ft.)) of piping above the slag removal equipment (e.g., a slag sump, at least one flash drum, control valves, a lock hopper, and so forth). Accordingly, the gasifier blow down does not need to be separated in as many stages during flash vaporization.

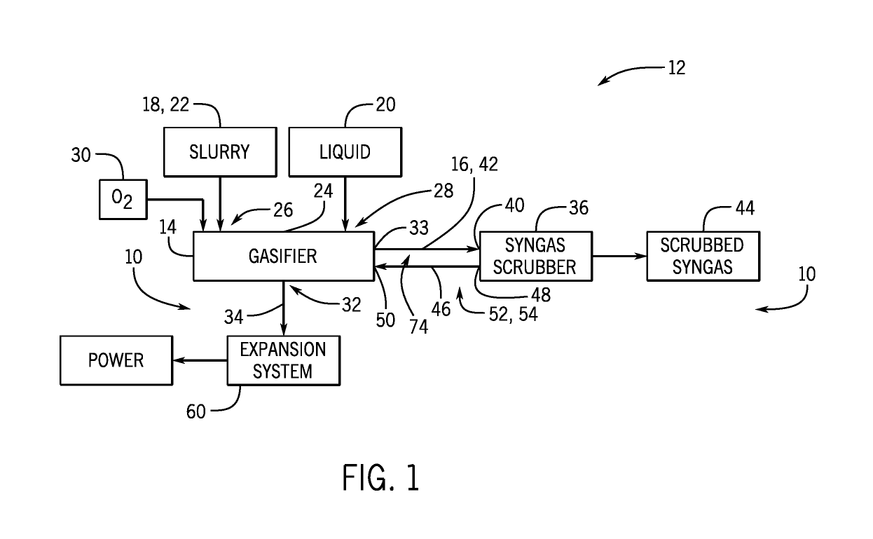

Turning now to the drawings, FIG. 1 is a schematic overview of an embodiment a continuous slag removal system 10. In the illustrated embodiment, the continuous slag removal system 10 is utilized in a power plant 12. The power plant 12 may include an integrated gasification combined cycle (IGCC) plant, a hybrid power plant (e.g., including a combination of internal combustion engines such as gas engines and gas turbines), a cogeneration plant, a diesel and/or biofuel plant, or other suitable power plant. The power plant 12 includes a gasifier 14 configured to produce a synthesis gas (i.e. syngas) 16. The gasifier 14 receives a fuel 18, which may be a liquid 20 or a suspension of solids in the form of a slurry 22, through a gasifier inlet 24 (e.g., a slurry inlet 26, a liquid inlet 28). The fuel 18 may be utilized as a source of energy for the power plant 12. The fuel 18 may include coal, petroleum coke, oil, biomass, wood based materials, agricultural wastes, tars, asphalt, or other carbon containing materials. The fuel 18 and oxygen 30 may be fed to a gasifier 14. The oxygen 30 may include, but is not limited to, high purity oxygen, air, enriched air, or any other oxygen-containing mixtures. The gasifier 14 converts the fuel 18 into the syngas 16, e.g., a combination of carbon monoxide and hydrogen. The syngas 16 is directed from the gasifier 14 through a syngas outlet 33. In addition, the gasifier 14 may produce other gases such as, but not limited to, CO₂, H₂O, N₂, Ar, CH₄, HCl, HF, COS, NH₃, HCN, and H₂S. The gasifier 14 also includes a gasifier outlet 31, from which the quench blow down 32 is removed.

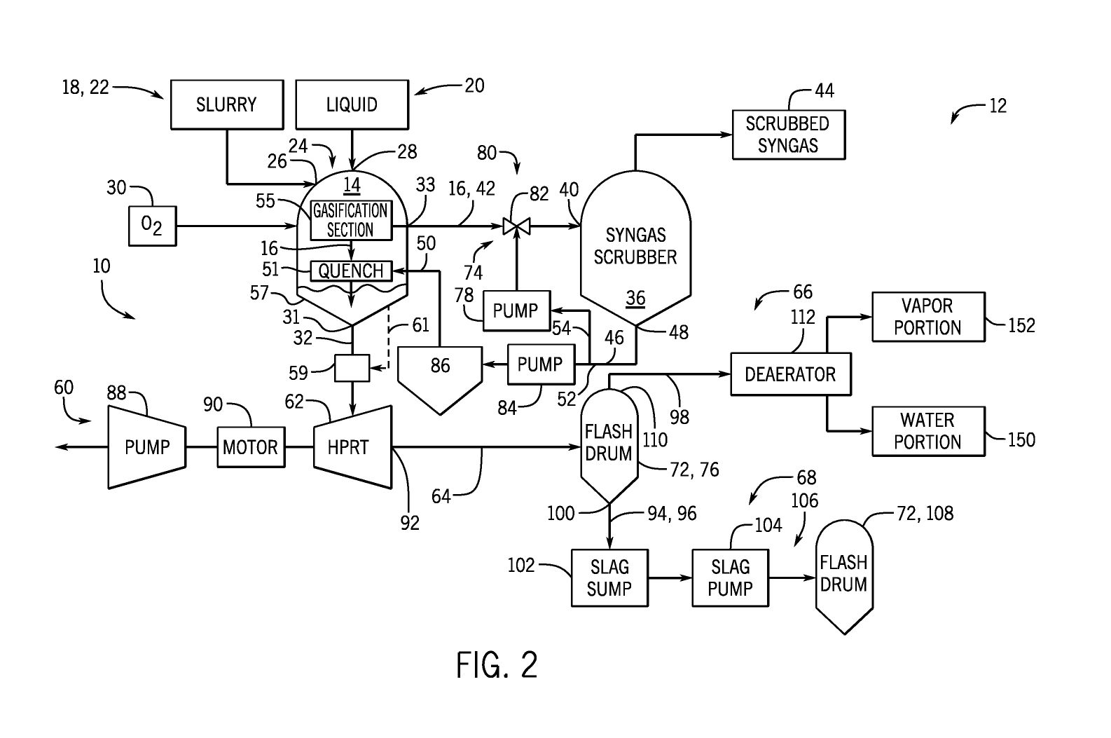

In the illustrated embodiment, the gasifier 14 is fluidly coupled to a syngas scrubber 36 disposed downstream of the gasifier 14. The syngas scrubber 36 includes a syngas inlet 40 configured to receive the syngas 16. The syngas 16 is transported from the syngas outlet 33 of the gasifier to the syngas inlet 40 through a syngas conduit 42. The syngas conduit 42 is generally intended to denote a flow path including one or more pipes configured to flow the syngas 16. As described in detail below, the syngas scrubber 36 is configured to discharge a scrubbed syngas 44 generated from scrubbing the syngas 16 and a scrubber blow down 46 that is discharged through a scrubber blow down outlet 48. The scrubber blow down outlet 48 is fluidly coupled to a fluid inlet 50 of the gasifier 14. The fluid inlet 50 of the gasifier 14, the syngas outlet 33, or both may be disposed between the slurry inlet 24 and the gasifier outlet 32. A portion of the scrubber blow down 46 may be directed to a scrubber blow down path 52 and a flow path 54, as explained further in the discussion of FIG. 2. The scrubber blow down path 52 directs the flow 54 (e.g., scrubber blow down 46) from the syngas scrubber 36 back to the gasifier 14.

The gasifier 14 is fluidly coupled to an expansion system 60 through the gasifier outlet 31. The gasifier outlet 31 directs the quench blow down 32 to the expansion system 60. By utilizing the expansion system 60 in the continuous slag removal system 10, the gasifier 14 may be able to be positioned closer to ground level. As described above, positioning the gasifier 14 closer to ground level enables equipment associated with traditional slag removal systems to be reduced or eliminated. In one embodiment, the expansion system 60 may include a hydraulic power recovery turbine.

The hydraulic power recovery turbine may be driven by the quench blow down 32 received from the gasifier outlet 31. In some embodiments, the hydraulic power recovery turbine may be driven by other sources. The hydraulic power recovery turbine may be used to generate electrical and/or mechanical energy in response to the flow of the gasifier blow down 46 flowing through the hydraulic power recovery turbine. As such, the electrical and/or mechanical energy may be utilized to drive a load, such as a pump, a generator, an engine, or a combination thereof.

FIG. 2 is a schematic diagram of an embodiment of the continuous slag removal system 10. As described above, the gasifier 14 is fluidly coupled by the syngas outlet 33 to the syngas scrubber 36 through the syngas inlet 40. All or a portion of the syngas 16 is transported to the syngas scrubber 36 via a syngas conduit 42 along a syngas path 74. In some embodiments, the remaining portion of the syngas 16 is transported directly to a quench section 51 of the gasifier 14. The syngas 16 is scrubbed in the syngas scrubber 36, and the scrubbed syngas 44 is separated from the syngas scrubber blow down 46. At least a portion of the scrubber blow down 46 may be directed through the scrubber blow down outlet 48 and into the scrubber blow down path 52 and the flow path 54. The scrubber blow down that may be sent to a gasification section 55 of the gasifier 14 may be approximately 70 to 90% of the total scrubber blow down 46. Thus, the remaining portion of the scrubber blow down 46 (e.g., approximately 10 to 30%) may be directed to the flow path 54. The portion of the scrubber blow down being directed to the flow path 54 may be directed back to the syngas conduit 42 via scrubber pump 78. The scrubber pump 78 may move the fluid (e.g., the scrubber blow down 54) to a location 80 along the syngas path 74 that is between the syngas outlet 33 of the gasifier and the syngas inlet 40 of the syngas scrubber 36.

As illustrated, the scrubber blow down path 52 directs the scrubber blow down 46 from the syngas scrubber 36 back to the gasifier 14. The scrubber blow down 46 may be moved along the scrubber blowdown path 52, and moved via a quench water pump 84. The quench water pump 84 may be disposed upstream of a quench water strainer 86. The quench water strainer 86 may remove at least a portion of particulate matter that may be present in the scrubber blowdown 46. After passing through the quench water strainer 86, the scrubber blow down 46 enters the gasifier 14 via a fluid inlet 50. The fluid inlet 50 is configured to direct the scrubber blow down 46 into the quench section 51 of the gasifier 14 to cool the solids (e.g., slag) output from the gasifier section 55. The scrubber blow down 46 may be used to cool the syngas 16 and the slag generated in the gasifier section 55 of the gasifier 14. A slag sump 57 may receive the slag and the syngas 16 as it leaves the quench section 51. The slag sump 57 may be used to reduce temperature of the syngas 16 and slag to quench the molten slag. In one embodiment, the quench blow down 32 flows through one or more slag crushers 59 to enable the solids content of the quench blow down 32 to be diluted to less than approximately 5%. Prior to the expulsion of the quench blow down 32 from the gasifier 14, a quench sump liquid 61 may be mixed with the quench blow down 32 to facilitate the reduction in solids content of the quench blow down 32 and to increase the flow rate of the quench blow down 32 to the expansion system 60. Advantageously, the lower solids concentration of the quench blow down 32 enables a direct flow path from the gasifier 14 to the expansion system 60 without the need for additional components or assemblies that would otherwise be used to urge the quench blow down 32 to the expansion system 60.

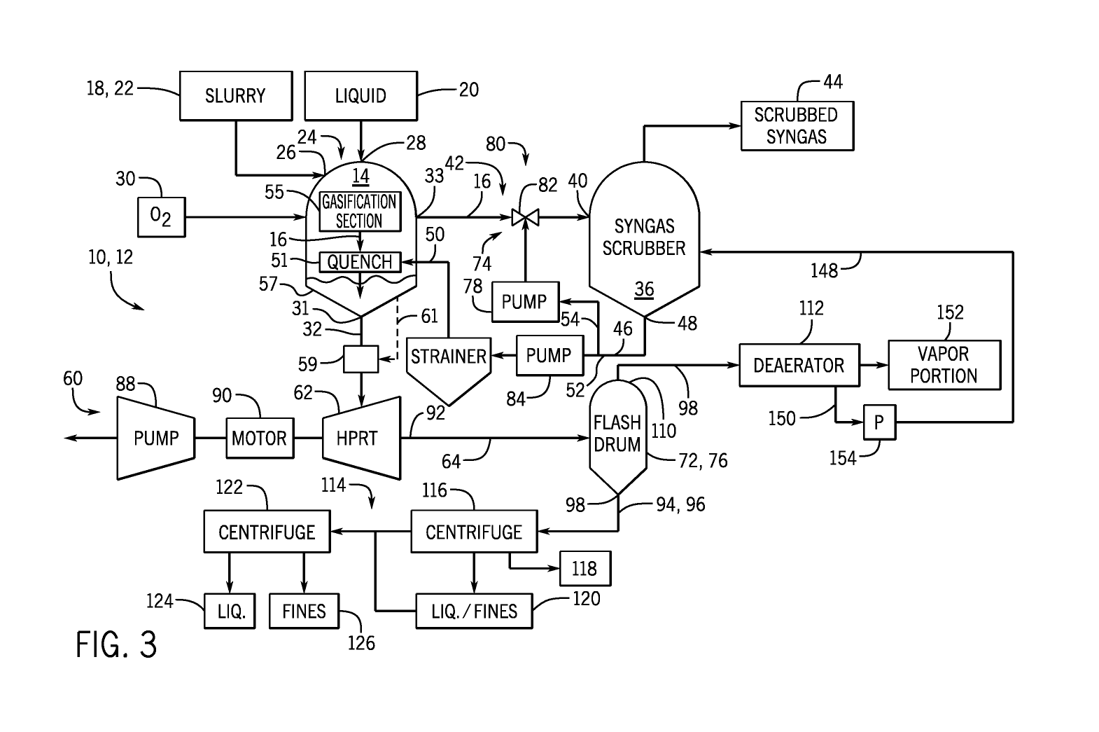

The expansion system 60 (e.g., the hydraulic power recovery turbine 62) receives the quench blow down 32. The hydraulic power recovery turbine 60 may be at least partially driven by the gasifier blow down 46 received from the gasifier outlet 32. The hydraulic power recovery turbine 62 may be used to generate electrical and/or mechanical energy in response to of the quench blow down 32 flowing through the hydraulic power recovery turbine 62. In the illustrated embodiment, for example, the electrical and/or mechanical energy may be utilized to drive a pump 88. In the illustrated embodiment, the pump 88 is driven by a motor 90. The hydraulic power recovery turbine 62 includes an expansion system outlet 92. The expansion system outlet 92 directs an expanded gasifier blow down 64 from the expansion system 60 (e.g., the hydraulic power recovery turbine 62) to the water treatment system 66 including one or more flash drums 72. The one or more flash drums 72 may include a first flash drum 76 configured to remove vapor from the expanded gasifier blow down 64. The first flash drum 76 may separate the expanded gasifier blow down 64 into a solid portion 94, a liquid portion 96, and a vapor portion 98. The solid portion 94 and the liquid portion 96 may be expelled through a bottoms discharge outlet 100 to a slag sump 102. The slag sump 102 removes slag from the liquid portion 96. The liquid portion 96, along with fines, flows along a flow path 106 to a second flash drum. The vapor portion 98 may be subject to further treatment, as shown. In the illustrated embodiment, the vapor portion 98 that is expelled through an overhead discharge outlet 110 of the flash drum 76 may be sent to a deaerator 112. As explained further with reference to the discussion of FIG. 3, the flows exiting the deaerator 112 may be used as a recycle feed for the syngas scrubber 36 thereby reducing total water consumption of the syngas scrubber 36.

FIG. 3 is a schematic diagram of an embodiment of the power plant 12 in which the water processing system 66 includes one or more centrifuges 114. More particularly, in the illustrated embodiment, the expansion system 60 includes the first flash drum 76 fluidly coupled to a pair of centrifuges 114. As shown, the bottoms 94, 96 exit the flash drum 76 and enters a first centrifuge 116 for separation into a solid portion 118 and a liquid portion 120. The liquid portion 120 may contain fine solid particles and may be directed to a second centrifuge 122 for further separation. A second liquid portion 124 is separated from a second solid portion 126 (e.g., fines) in the second centrifuge 122.

As described above, the first flash drum 76 may separate the expanded gasifier blow down 64 into the solid portion 94, the liquid portion 96, and the vapor portion 98. The vapor portion 98 may be further processed in the deaerator 112. Deaeration is accomplished by scrubbing the vapor portion 98. Scrubbing may separate the vapor portion 98 into a deaerated water portion 150 and a vapor portion 152. The deaerated water portion 150 provides a water feed and is directed to the syngas scrubber 36. A deaerator pump 154 may be used to move the deaerated water portion 150 to the syngas scrubber 36.

Technical effects of the claimed subject matter include utilizing the continuous slag removal system to optimize slag removal systems used with gasification systems. The disclosed embodiments provide several benefits, including, diluting the amount of solids in the gasifier blow down. Diluting the solids concentration expelled by the gasifier includes using a scrubber blow down from a syngas scrubber fluidly coupled to the gasifier. The disclosed embodiments may also provide the added benefit of reducing the amount of equipment in the continuous slag removal system by utilizing an expansion system. The expansion system may include a hydraulic power recovery turbine. Utilizing the hydraulic power recovery turbine provides an additional benefit of being able to install the gasifier at ground level, thereby reducing the amount of equipment used to continually remove the slag. The expansion system enables the continuous slag removal system to be further optimized by reducing the amount of equipment utilized in the water treatment system. The continuous slag removal system may reduce the number of flash drums utilized to process and treat the black water.

This written description uses examples to disclose the claimed subject matter, including the best mode, and also to enable any person skilled in the art to practice the claimed subject matter, including making and using any devices or systems and performing any incorporated methods. The patentable scope of the claimed subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gasifier comprising:
a slurry inlet of the gasifier configured to receive a feedstock slurry;
a gasification section of the gasifier configured to gasify the feedstock slurry to produce syngas;
a quench chamber of the gasifier configured to cool the syngas produced in the gasification section using a liquid feed to produce a quench blow down and quenched syngas, the quench blow down having solids produced as a by-product from gasification of the feedstock slurry and the liquid feed;
a quench blowdown outlet configured to discharge the quench blow down in combination with a slag sump liquid such that the solids concentration of the quench blowdown is reduced by the slag sump liquid;
a syngas outlet configured to discharge the syngas; and
a syngas scrubber fluidly coupled to the syngas outlet and to the quench chamber, wherein the syngas scrubber comprises a syngas inlet fluidly coupled to the syngas outlet of the gasifier, a scrubbed syngas outlet configured to discharge scrubbed syngas generated from scrubbing the syngas, and a scrubber blow down outlet fluidly coupled to a fluid inlet of the gasifier and configured to provide a scrubber blow down to the quench chamber as all or a part of the liquid feed.

2. The system of claim 1, comprising a scrubber blow down path extending from the scrubber blow down outlet and to the fluid inlet of the gasifier, and the scrubber blow down path is configured to direct a flow of the scrubber blow down to the gasifier to provide a source of water configured to reduce a solids concentration of the quench blow down.

3. The system of claim 2, comprising a quench pump and a quench strainer disposed along the scrubber blow down path extending from the scrubber blow down outlet and to the fluid inlet of the gasifier, wherein the quench strainer is configured to remove solids from the flow of the scrubber blow down to the gasifier.

4. The system of claim 1, comprising an expansion system fluidly coupled to the quench blow down outlet, wherein the expansion system is driven by at least the quench blow down, and the expansion system comprises an expansion system outlet configured to discharge an expanded quench blow down generated by extracting work from the quench blow down.

5. The system of claim 4, wherein the expansion system comprises a hydraulic power recovery turbine, and the expansion system is configured to generate electrical or mechanical power in response to a flow of the quench blow down through the hydraulic power recovery turbine.

6. The system of claim 4, comprising a flash drum fluidly coupled to the expansion system outlet and configured to subject the expanded gasifier blow down to flash vaporization.

7. The system of claim 6, wherein the flash drum comprises an overhead discharge outlet and a bottoms discharge outlet, and wherein the overhead discharge outlet is fluidly coupled to a deaerator.

8. The system of claim 7, wherein a portion of an output of the deaerator is deaerated to provide a water feed to the syngas scrubber.

9. The system of claim 6, wherein the flash drum comprises an overhead discharge outlet and a bottoms discharge outlet, and wherein the bottoms discharge outlet is fluidly coupled to a slag sump.

10. The system of claim 6, wherein the flash drum comprises an overhead discharge outlet and a bottoms discharge outlet, and wherein the bottoms discharge outlet is fluidly coupled to a centrifuge.

11. The system of claim 1, comprising a flow path fluidly coupling the scrubber blow down outlet with a syngas path, wherein the syngas path extends from the syngas outlet of the gasifier and to the syngas inlet of the syngas scrubber, wherein the flow path is configured to introduce a flow of the scrubber blow down into the syngas path at a location between the syngas outlet of the gasifier and the syngas inlet of the syngas scrubber.

12. The system of claim 1, wherein the quench blow down and the scrubbed blow down are directed to the hydraulic power recovery turbine to dilute the solids concentration of the quench blow down.

13. The system of claim 11, comprising a pump configured to introduce the flow of the scrubber blow down into the syngas path at the location between the syngas outlet of the gasifier and the syngas inlet of the syngas scrubber.

14. A system, comprising:
a gasifier comprising a slurry inlet configured to receive a slurry, a quench blow down outlet configured to discharge a quench blow down, and a syngas outlet configured to discharge syngas produced from gasification of the slurry;
a syngas scrubber comprising a syngas inlet fluidly coupled to the syngas outlet of the gasifier, a scrubbed syngas outlet configured to discharge scrubbed syngas generated from scrubbing the syngas, and a scrubber blow down outlet fluidly coupled to a fluid inlet of the gasifier and configured to provide a scrubber blow down; and
an expansion system fluidly coupled to the gasifier outlet, wherein the expansion system comprises a hydraulic power recovery turbine, and the expansion system receives the quench blow down and a slag sump liquid, wherein the solids concentration of the quench blow down is reduced by the slag sump liquid.

15. The system of claim 14, comprising a flow path fluidly coupling the scrubber blow down outlet with a syngas path, wherein the syngas path extends from the syngas outlet of the gasifier and to the syngas inlet of the syngas scrubber, and wherein the flow path is configured to introduce a flow of the scrubber blow down into the syngas path at a location between the syngas outlet of the gasifier and the syngas inlet of the syngas scrubber.

16. The system of claim 15, comprising a flash vessel configured to discharge portions of the expanded gasifier blow down into an overhead discharge outlet and a bottoms discharge outlet, wherein the overhead discharge outlet is fluidly coupled to a deaerator configured to generate a water feed to the syngas scrubber, and wherein the bottoms discharge outlet is fluidly coupled to a slag sump.

17. A method, comprising:
directing a fluid exiting a syngas scrubber disposed downstream and coupled to a gasifier to a fluid inlet of the gasifier, wherein the fluid inlet is disposed between a gasifier inlet and a quench blow down outlet disposed along a bottom portion of the gasifier;
discharging a quench blow down comprising a quenched syngas generated in a gasification section of the gasifier through the quench blow down outlet; and
directing the gasifier blow down and a slag sump liquid to a hydraulic power recovery turbine system.

18. The method of claim 17, wherein the fluid is directed to the fluid inlet of the gasifier until a concentration of solids in the gasifier blow down is less than 5%.

19. The method of claim 17, comprising driving a load coupled to the hydraulic power recovery system in response to a flow of the gasifier blow down through the hydraulic power recovery turbine system.

20. The method of claim 17, comprising directing an expanded quench blow down from the hydraulic power recovery system to a water treatment system, and treating the expanded quench blow down to produce a water feed for the syngas scrubber.
